(19) United States
(12) Patent Application Publication
(10) Pub. No.: US 2016/0021284 A1
(43) Pub. Date: Jan. 21, 2016

(54) PHOTOELECTRIC CONVERSION APPARATUS, AND IMAGING SYSTEM USING THE SAME

(71) Applicant: CANON KABUSHIKI KAISHA, Tokyo (JP)

(72) Inventor: Tomoyuki Tezuka, Sagamihara-shi (JP)

(21) Appl. No.: 14/796,963

(22) Filed: Jul. 10, 2015

(30) Foreign Application Priority Data
Jul. 16, 2014 (JP) 2014-146012
May 21, 2015 (JP) 2015-103997

(51) Int. Cl. H04N 5/225; G02B 5/20

(52) U.S. Cl. CPC H04N 5/2254; G02B 5/20

(57) ABSTRACT

An apparatus having a first region including a photoelectric conversion element, and a second region, includes a member provided above the second region and only arranged in the second region in a planar view, and a color filter layer including color filters with a plurality of colors that is provided across the first and second regions and positioned above the member. The color filter layer includes a color filter with a first color provided across the first and second regions to cover a difference in level caused by the member. The color filter with the first color has a first thickness d1 at a first position in the first region, a second thickness d2 at a second position in the second region, and a third thickness d3 at a third position between the first and second positions. These thicknesses satisfy relations d3>d1 and d3>d2.

### BACKGROUND OF THE INVENTION

1. Field of the Invention

The present invention relates to a photoelectric conversion apparatus and an imaging system using the same.

2. Description of the Related Art

There have been known photoelectric conversion apparatuses including a light receiving region and a light-shielded region. Japanese Patent Application Laid-Open No. 2010-267675 discloses a photoelectric conversion apparatus including a light receiving pixel region, an ineffective pixel region (a light-shielded region), and an optical black region (OB region). Japanese Patent Application Laid-Open No. 2010-267675 discloses a configuration of providing wiring layers in a stepped manner so as to reduce a difference in the level generated between the number of wiring layers of the light receiving pixel region and the ineffective pixel region, and the number of wiring layers of the OB region.

As described in Japanese Patent Application Laid-Open No. 2010-267675, even if the difference in the level is reduced, in the case of forming a color filter layer on an uneven surface, when a material layer forming the color filter layer is formed, the material layer can be locally thickened. The locally-thickened portion of the material layer may not be sufficiently exposed to light during an exposure process to be performed next. Consequently, the resultant color filter layer may be peeled off.

### SUMMARY OF THE INVENTION

According to an aspect of the present invention, a photoelectric conversion apparatus has a first region including a photoelectric conversion element, and a second region. The photoelectric conversion apparatus includes a first light shielding film arranged in the second region in a planar view, a second light shielding film arranged in the first region and the second region so as to overlap with the first light shielding film in a planar view, and a color filter layer including color filters with a plurality of colors that is provided across the first region and the second region, and positioned above the first light shielding film and the second light shielding film. The color filter layer includes a color filter with a first color that extends from, in a planer view, a region in which the first light shielding film and the second light shielding film overlap with each other to a region in which the second light shielding film is provided and the first light shielding film and the second light shielding film do not overlap with each other, so as to cover a difference in the level caused by the first light shielding film. The color filter with the first color has a first thickness dl at a first position in the first region, a second thickness d2 at a second position in the second region that is above the first light shielding film, and a third thickness d3 at a third position between the first position and the second position. The first thickness d1, the second thickness d2, and the third thickness d3 satisfy relations d3>d1 and d3>d2.

Further features of the present invention will become apparent from the following description of exemplary embodiments with reference to the attached drawings.

### BRIEF DESCRIPTION OF THE DRAWINGS

FIG. 1 is a diagram for illustrating a photoelectric conversion apparatus according to the present invention.

FIGS. 2A and 2B are a schematic cross sectional view and a schematic plan view, respectively, for illustrating a photoelectric conversion apparatus according a first exemplary embodiment.

FIGS. 3A and 3B are schematic plan views for illustrating the photoelectric conversion apparatus according the first exemplary embodiment.

FIG. 4 is a schematic cross sectional view for illustrating a photoelectric conversion apparatus according a second exemplary embodiment.

FIGS. 5A and 5B are schematic plan views for illustrating a photoelectric conversion apparatus according a third exemplary embodiment.

FIGS. 6A and 6B are schematic plan views for illustrating a photoelectric conversion apparatus according a fourth exemplary embodiment.

### DESCRIPTION OF THE EMBODIMENTS

### First Exemplary Embodiment

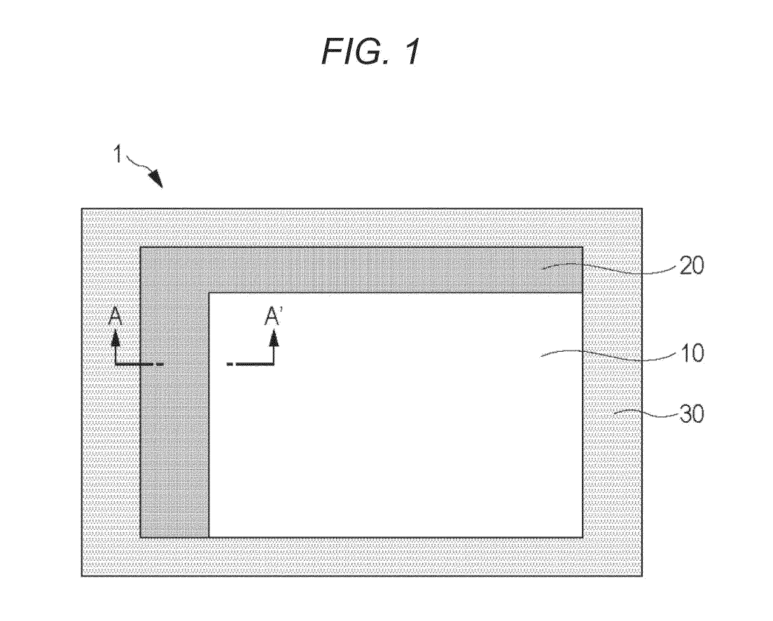

A first exemplary embodiment of the present invention will be described with reference to FIG. 1. Well-known or publicly known techniques of corresponding technical fields are applied to parts not especially illustrated in the drawings or described in the specification. Each exemplary embodiment described below is merely an exemplary embodiment of the present invention, and the present invention is not limited to the exemplary embodiments described below.

FIG. 1 is a planar layout view of a photoelectric conversion apparatus 1. The photoelectric conversion apparatus 1 illustrated in FIG. 1 includes a light receiving pixel region 10, a light-shielded pixel region 20, and a peripheral circuit region 30. The light-shielded pixel region 20 is a region provided outside of the light receiving pixel region 10. In the light receiving pixel region 10 and the light-shielded pixel region 20, a plurality of pixels is arranged in a two-dimensional array. The peripheral circuit region 30 is a region for controlling an operation of the light receiving pixel region 10, and for processing a signal read from the light receiving pixel region 10. The examples of the peripheral circuit region 30 include an amplification circuit, a horizontal scanning circuit, and a vertical scanning circuit. When viewed from a direction vertical to the surface of a semiconductor substrate, the light-shielded pixel region 20 and the peripheral circuit region 30 are each covered with a light shielding film. Meanwhile, when viewed from a direction vertical to the surface of the semiconductor substrate (in a planar view), the light receiving pixel region 10 is not provided with a light shielding film, or provided with a light shielding film having an opening for each pixel, so that light reaches a semiconductor region. At least a part of pixels arranged in the light-shielded pixel region 20 is an optical black pixel (OB pixel), and a signal obtained by the OB pixel is used as a noise signal.

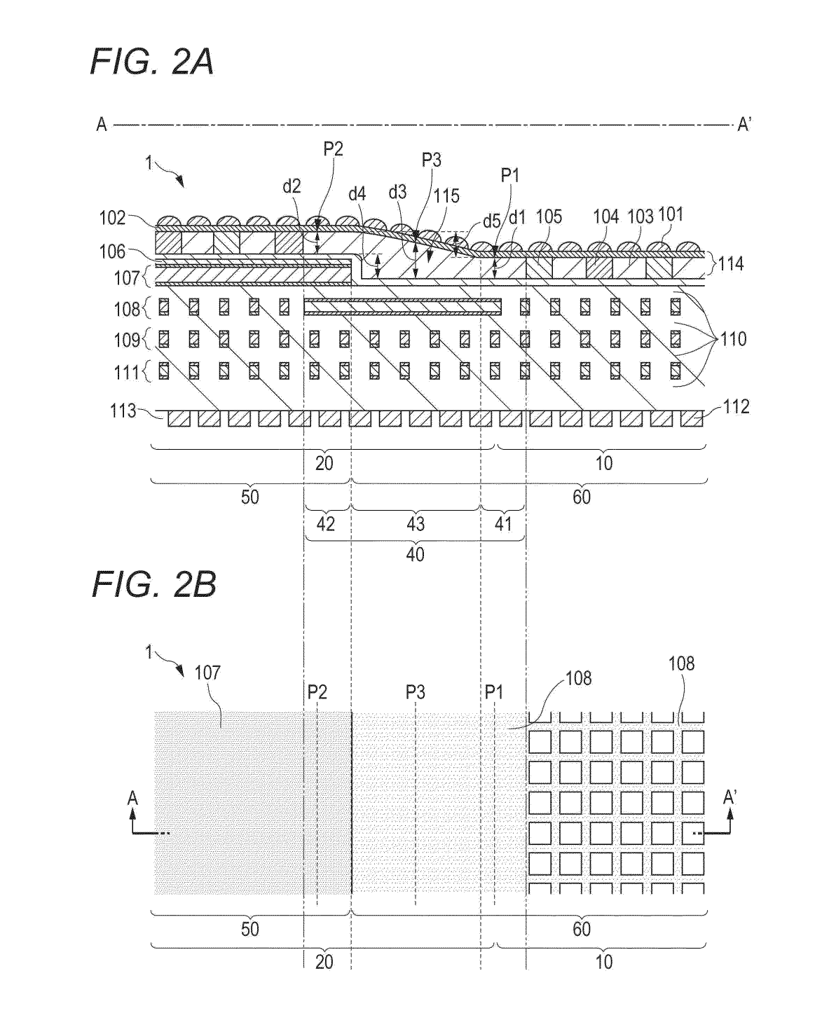

FIG. 2A is a view illustrating a cross section taken along a line A-A′ in the planar layout view illustrated in FIG. 1. As illustrated in FIG. 2A, in the light receiving pixel region 10 and the light-shielded pixel region 20, a plurality of photoelectric conversion elements 112 arranged in a row direction and a column direction is provided in a semiconductor substrate (hereinafter, simply also referred to as a substrate) 113. The plurality of photoelectric conversion elements 112 is arrayed along the surface of the semiconductor substrate 113. For simplification of the drawing, a metal oxide semiconductor (MOS) transistor provided in the semiconductor substrate 113 is not illustrated.

In the following description of the present invention, one pixel region refers to a minimum unit constituting each region in the light receiving pixel region 10 and the light-shielded pixel region 20. In other words, one pixel region refers to a repeatedly-arranged minimum-unit configuration including the photoelectric conversion element 112 provided in the semiconductor substrate 113 and other components such as a gate electrode (not illustrated) and an electric charge detection region (not illustrated).

A plurality of insulating films 110, a first wiring layer 111, a second wiring layer 109, a third wiring layer 108, and a fourth wiring layer 107 are provided above the semiconductor substrate 113. For simplification of the drawing, metal plugs for connecting between a wiring layer and the semiconductor substrate 113, between a gate electrode and a wiring layer, and between wiring layers are not illustrated. The plurality of insulating films 110 includes, for example, a silicon oxide film. The first wiring layer 111, the second wiring layer 109, the third wiring layer 108, and the fourth wiring layer 107 are formed of, for example, metal containing aluminum or copper as a main component, or a conductive intermetallic compound. Barrier films such as titanium nitride are provided on and under these conductive materials. The fourth wiring layer 107 is covered with a base film 106. A color filter layer 114 is formed on the base film 106. The base film 106 is formed of, for example, organic material, and is a film for increasing the adhesiveness of the color filter layer 114. The base film 106 is a conformal film having a top surface following a shape of the fourth wiring layer 107. The color filter layer 114 includes a plurality of predetermined color filters arranged for each pixel so as to mainly transmit light of a predetermined wavelength. For example, the color filter layer 114 includes color filters 103, 104, and 105 with a plurality of colors, and is formed of photoresist. A planarized layer 102 is formed on the color filter layer 114. The planarized layer 102 is formed of, for example, a silicon oxide film, or organic material such as resin. A microlens layer 101 is provided on the planarized layer 102. The microlens layer 101 includes a plurality of microlenses. In the present exemplary embodiment, one microlens is arranged corresponding to one pixel. The microlens layer 101 is formed of, for example, organic material such as acrylic resin and polystyrene resin, or inorganic material such as a silicon oxide film.

FIG. 2B is a schematic view illustrating, in a planar view, the third wiring layer 108 and the fourth wiring layer 107 of a portion corresponding to FIG. 2A. In the present exemplary embodiment, the third wiring layer 108 provided in the light receiving pixel region 10 includes a plurality of openings respectively corresponding to a plurality of pixels. In contrast, the third wiring layer 108 provided in the light-shielded pixel region 20 includes no opening. Thus, the third wiring layer 108 provided in the light-shielded pixel region 20 can function as a light shielding film. In addition, the fourth wiring layer 107 having no opening is provided in the light-shielded pixel region 20. The fourth wiring layer 107 can function as a light shielding film. In other words, the fourth wiring layer 107 forms a first light shielding film, and part of the third wiring layer 108 forms a second light shielding film. The first light shielding film and the second light shielding film are provided in the light-shielded pixel region 20. In addition, the second light shielding film serves as an element forming the third wiring layer 108 which is a wiring layer provided one level below the fourth wiring layer 107.

The arrangement of a plurality of wiring layers will now be described with reference to FIGS. 2A and 2B. First, the first wiring layer 111, the second wiring layer 109, and the third wiring layer 108 are arranged above the light receiving pixel region 10. Meanwhile, in addition to the first wiring layer 111, the second wiring layer 109, and the third wiring layer 108, the fourth wiring layer 107 is arranged above the light-shielded pixel region 20. In contrast, the fourth wiring layer 107 is not arranged above the light receiving pixel region 10.

In other words, in the photoelectric conversion apparatus 1, there are a region 50 provided with the fourth wiring layer 107, and a region 60 not provided with the fourth wiring layer 107. A boundary between the regions 50 and 60 corresponds to a position of an end portion of the fourth wiring layer 107. In the present exemplary embodiment, a side surface of the fourth wiring layer 107 is positioned at the boundary between the regions 50 and 60. At this time, the light-shielded pixel region 20 includes the regions 50 and 60, and the light receiving pixel region 10 includes the region 60.

In FIGS. 2A and 2B, the fourth wiring layer 107 has a thickness d4, and the boundary between the regions 50 and 60 has a difference in the level corresponding to the thickness d4. In such a configuration, in the present exemplary embodiment, a color filter 115 with a first color of the color filter layer 114 is provided so as to cover the difference in the level between the regions 50 and 60. In addition, in a planar view, the color filter 115 with the first color extends from a region in which the second light shielding film and the first light shielding film overlap with each other to a region in which the second light shielding film is provided and the first light shielding film and the second light shielding film do not overlap with each other. The color filter 115 with the first color has a thickness dl at an arbitrary position P1 in the region 60 that is above the second light shielding film, and a thickness d2 at an arbitrary position P2 in the region 50 that is above the first light shielding film. In addition, the color filter 115 with the first color has a thickness d3 at a position P3 between the positions P1 and P2. In other words, the color filter 115 with the first color has a portion 41 having the thickness dl, a portion 42 having the thickness d2, and a portion 43 having the thickness d3. These thicknesses d1 to d3 satisfy relations d3>d1 and d3>d2. The color filter 115 with the first color as described above is included, whereby peel-off of a color filter can be reduced when color filters with a plurality of colors are formed on the surface having a difference in the level.

The peel-off of a color filter will now be described. For example, when the color filter 115 with the first color is formed of negative resist, after a photosensitive material layer forming the color filter is formed, an arbitrary pattern is exposed to light and developed, thereby forming the color filter 115 with the first color. At this time, the material layer covers the difference in the level generated between the positions P1 to P3, and is formed up to the position P2. If this material layer is exposed to light, a portion of the material layer that corresponds to the portion 43 may not obtain a sufficient amount of exposure. Meanwhile, portions of the material layer that respectively correspond to the portions 41 and 42 are sufficiently exposed to light. The portions 41 and 42 of the color filter 115 with the first color that are formed in the above manner have sufficient adhesiveness between themselves and the base. Thus, sandwiching the portion 43 between the portions 41 and 42 can reduce the possibility of the generation of peel-off. In addition, in a case in which the color filter layer 114 of the present exemplary embodiment is formed of positive resist, when patterning is performed so as to remove the material layer at the position P3, a sufficient amount of exposure may not be obtained at the position P3, so that the material layer may remain. If the portion 43 is not patterned but provided up to the portions 41 and 42 as in the present exemplary embodiment, patterning failure can be reduced.

Examples of thickness and width of each configuration will now be given. The thickness d4 of the fourth wiring layer 107 is 0.5 μm or more and 1.0 μm or less. In the present exemplary embodiment, the thickness d4 is assumed to be 0.7 μm. The thickness of the base film 106 is, for example, about 0.1 μm or more and 0.3 μm or less. The width of the color filter 115 with the first color is 20 μm or more and 40 μm or less, the thickness d1 is 0.7 μm, the thickness d2 is 0.6 μm, and the thickness d3 is 0.7 μm or more and 1.5 μm or less. At this time, a length d5, which is a difference between a top surface of the color filter layer 114 in the light receiving pixel region 10 and a top surface of the color filter layer 114 in the region 50, is smaller than the thickness d4 (d4>d5), and is 0.6 μm. In order that the color filter layer 114 obtains sufficient spectral characteristics, the thickness dl of a portion in the light receiving pixel region 10 may be equal to or thicker than the thickness d2 of a portion in the light-shielded pixel region 20 (d1≧d2). In the present exemplary embodiment, a thickness basically refers to a length of a member in a direction vertical to the surface of the semiconductor substrate 113, and a distance between a top surface and a bottom surface of the member. A width refers to a length of a member in a direction parallel to the surface of the semiconductor substrate 113, and a length along a top surface and a bottom surface of the member.

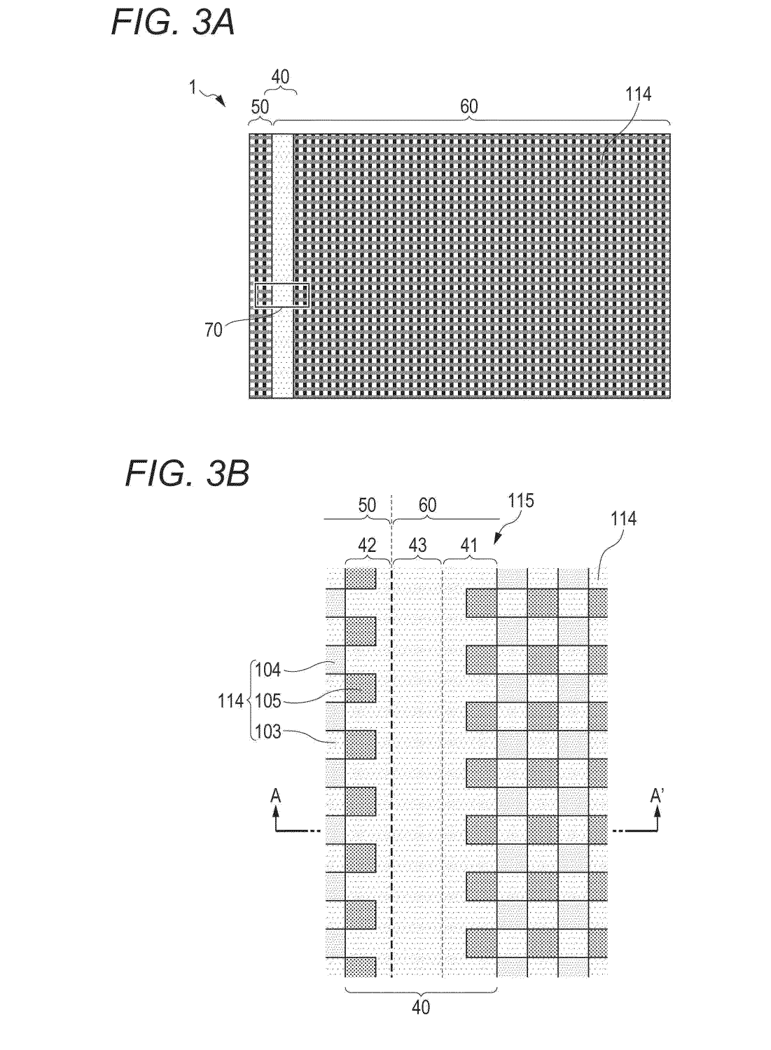

Next, the color filter layer 114 will be described. FIG. 3A is a schematic plan view illustrating the color filter layer 114 provided in the photoelectric conversion apparatus 1. In FIG. 3A, the region 50 is arranged in a belt shape (has a long side and a short side) along one side of the photoelectric conversion apparatus 1. The color filter layer 114 is formed across the regions 50 and 60. The color filter layer 114 includes color filters with a plurality of colors. In FIG. 3A, these color filters are arrayed in a regular pattern. In this example, the color filter layer 114 includes a portion 40 formed of the color filter 115 with the first color. This portion 40 will be described with reference to FIG. 3B.

FIG. 3B is a schematic plan view illustrating a region 70 of FIG. 3A in an enlarged manner. A line A-A′ illustrated in FIG. 3B corresponds to, for example, the line A-A′ illustrated in FIG. 1. The portion 40 formed of the color filter 115 with the first color is arranged so as to cover the difference in the level between the regions 50 and 60. In the location not provided with the portion 40, the color filters 103, 104, and 105 with the plurality of colors are arranged in, for example, a Bayer array. In the present exemplary embodiment, the color filter 115 with the first color is formed of the same material and at the same timing as the green color filter 103. In a planar view, the portion 43 has a belt shape with a linearly-configured outer edge while the portions 41 and 42 each have a shape with an outer edge having projections and depressions. Even with such a configuration, since the portion 43 is sandwiched between the portions 41 and 42, peel-off of the color filter layer 114 can be reduced. In the drawing, the color filter layer 114 is formed over the entire surface of the photoelectric conversion apparatus 1. The configuration of the color filter layer 114 is, however, not limited to such a configuration. The color filter layer 114 may be partially removed.

As illustrated in FIG. 2A, in the color filter layer 114, the color filters 103, 104, and 105 with the plurality of colors are also formed on the region 50. With this configuration, even when light enters a top surface of the fourth wiring layer 107, reflection of the light can be reduced. As a result, undesired light (stray light) can be reduced.

### Second Exemplary Embodiment

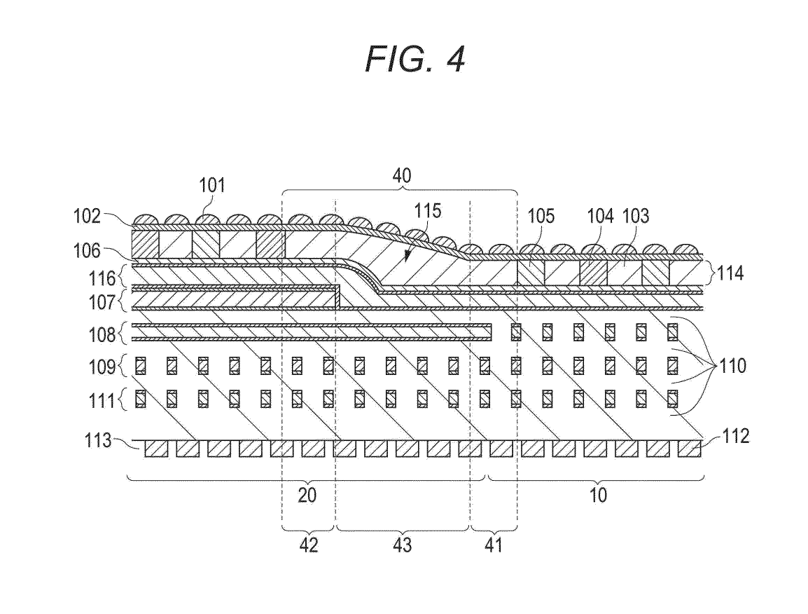

A photoelectric conversion apparatus according to the present exemplary embodiment will be described with reference to FIG. 4. In the present exemplary embodiment, a configuration and a manufacturing process similar to those in the first exemplary embodiment will not be described.

FIG. 4 is a schematic cross sectional view corresponding to FIG. 2A and illustrating the photoelectric conversion apparatus. The photoelectric conversion apparatus of the present exemplary embodiment includes a passivation film (hereinafter, also referred to as PV film) 116 in addition to the photoelectric conversion apparatus of the first exemplary embodiment. The PV film 116 is provided between the fourth wiring layer 107 and the base film 106. The base film 106 is formed of a silicon oxynitride film, a silicon nitride film, or a laminated film of these films. As a configuration example of the laminated film, a silicon oxynitride film, a silicon nitride film, and a silicon oxynitride film are stacked in this order from the bottom layer. The photoelectric conversion apparatus is provided with this PV film 116, whereby the difference in the level of the boundary between the regions 50 and 60 can be reduced, as compared with the difference in the level in the first exemplary embodiment. The width of the portion 40 can be accordingly narrowed.

In addition, the photoelectric conversion apparatus of the present exemplary embodiment differs from the photoelectric conversion apparatus of the first exemplary embodiment in that the third wiring layer 108 does not have an opening even in a portion in which the third wiring layer 108 overlaps with the fourth wiring layer 107. With this configuration, light straying into the light-shielded pixel region 20 can be reduced, as compared with the first exemplary embodiment.

### Third Exemplary Embodiment

In the present exemplary embodiment, another configuration of the color filter layer 114 will be described. In the present exemplary embodiment, a configuration and a manufacturing process similar to those in the first and the second exemplary embodiments will not be described.

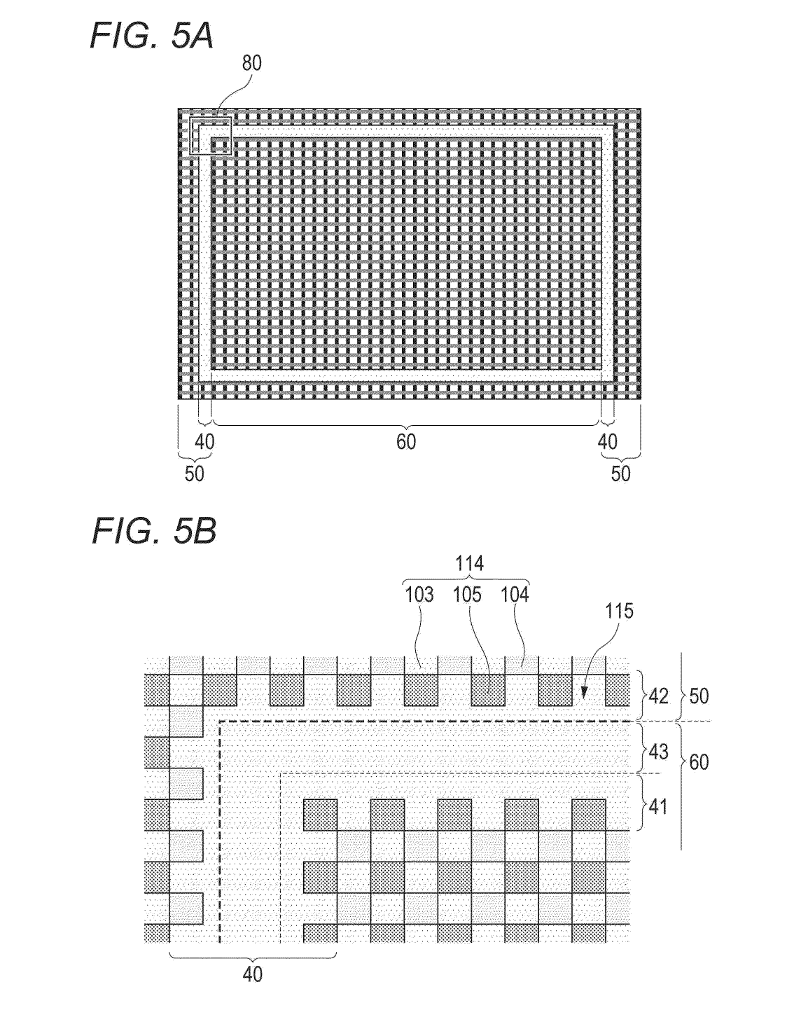

FIG. 5A is a schematic plan view illustrating the color filter layer 114 provided in the photoelectric conversion apparatus 1. FIG. 5A corresponds to FIG. 3A. In the present exemplary embodiment, the region 50 is provided along four sides of the photoelectric conversion apparatus 1, and has a frame shape. In other words, the fourth wiring layer 107 is provided along four sides of the photoelectric conversion apparatus 1. The portion 40 of the color filter layer 114 is provided not along only one side, but along four sides of the photoelectric conversion apparatus 1, and has a frame shape.

FIG. 5B is a schematic plan view illustrating a region 80 of FIG. 5A in an enlarged manner. In FIG. 5B, the portion 43 of the color filter layer 114 that has the thickness d3 is also provided along four sides of the photoelectric conversion apparatus 1, and has a frame shape. In addition, even at a corner portion in a planer view, the portion 43 is positioned between the portions 41 and 42. In this manner, the shapes of the portions 41, 42, and 43 of the color filter layer 114 may be set so as to accord with the shape of the region 50. For example, in a case in which the region 50 has a frame shape, the portions 41, 42, and 43 each may have a frame shape. Even in such a configuration, peel-off of the color filter layer 114 can be reduced.

### Fourth Exemplary Embodiment

In the present exemplary embodiment, another configuration of the color filter layer 114 will be described. In the present exemplary embodiment, a configuration and a manufacturing process similar to those in the first to the third exemplary embodiments will not be described.

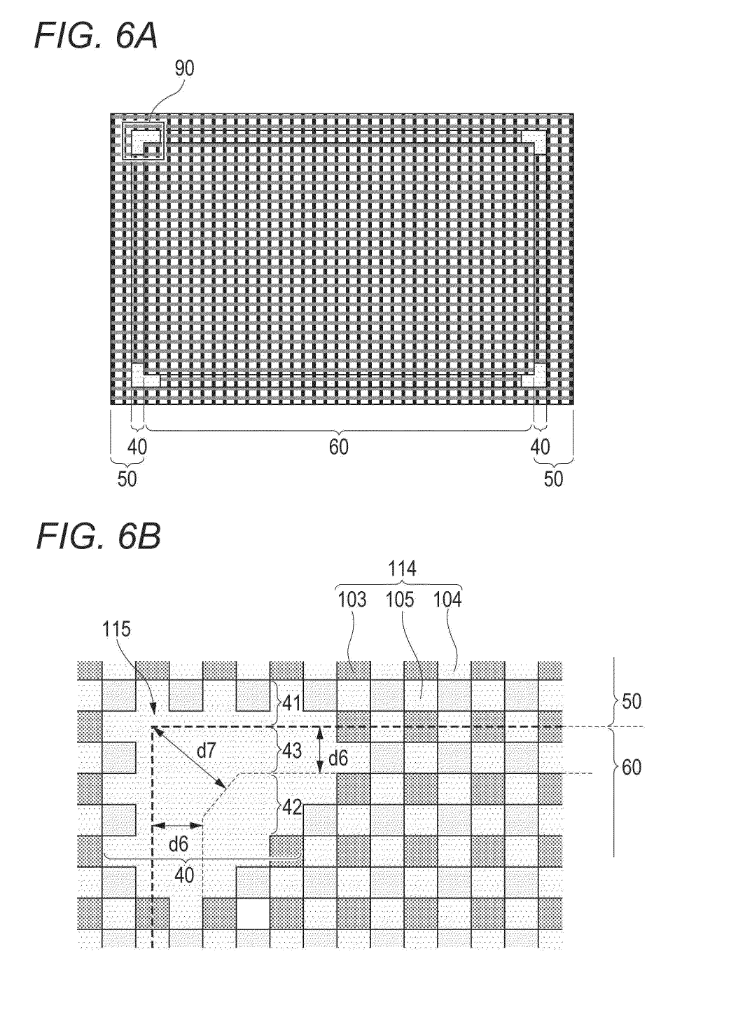

FIG. 6A is a schematic plan view illustrating the color filter layer 114 provided in the photoelectric conversion apparatus 1. FIG. 6A is a diagram corresponding to FIG. 3A or 5A. In the present exemplary embodiment, the region 50 is provided along four sides of the photoelectric conversion apparatus 1, and has a frame shape. In other words, the fourth wiring layer 107 is provided along four sides of the photoelectric conversion apparatus 1. In the present exemplary embodiment, the portion 40 of the color filter layer 114 is not provided along the region 50. Instead, the portions 40 are arranged only at corner portions of the frame of the region 50.

FIG. 6B is a schematic plan view illustrating a region 90 of FIG. 6A in an enlarged manner. In FIG. 6B, the portion 43 of the color filter layer 114 that has the thickness d3 becomes wider at a corner portion where the difference in the level is formed. Specifically, the portion 43 is provided on one side of the region 50 along the side of the photoelectric conversion apparatus, and has a width d6 on the side portion. In addition, the portion 43 has a width d7 larger than the width d6 at the corner portion. In particular, when the color filter layer 114 is formed, in a planer view, the material layer of the color filter layer 114 that is formed at the corner portion often has an increased thickness. Thus, the color filter 115 with the first color may be formed in such a manner that the portion 43 is positioned between the portions 41 and 42 even at a corner portion in a partially-planar view. Even with such a configuration, peel-off of the color filter layer 114 can be reduced. In addition, the configuration in the present exemplary embodiment and the shape in the third exemplary embodiment may be combined. In this case, the width of the portion 40 may be made larger at the corner portion, and to make the widths of the portions 41 and 42 larger as well.

As described above, according to each of the color filter layers 114 of the first to the fourth exemplary embodiments, peel-off of the color filter layer can be suppressed, and a photoelectric conversion apparatus can be provided.

As an application example of a photoelectric conversion apparatus according to each of the above exemplary embodiments, an example of an imaging system into which the photoelectric conversion apparatus is incorporated will be described below. The concept of the imaging system includes not only an apparatus having an imaging function as a main function, such as a camera, but also an apparatus (e.g., personal computer, mobile terminal) having an imaging function as an auxiliary function. The imaging system includes a photoelectric conversion apparatus according to the present invention that has been described as an example in any of the above exemplary embodiments, and a signal processing unit for processing a signal output from the photoelectric conversion apparatus. The signal processing unit can include, for example, an analog-to-digital (A/D) converter, and a processor for processing digital data output from the A/D converter.

In the first to the fourth exemplary embodiments, the difference in the level is assumed to be caused by the fourth wiring layer 107. Alternatively, the difference in the level may be caused by an insulating film having an end portion, and may be caused by any portion as long as the portion has the difference in the level. In the first to the fourth exemplary embodiments, the description has been given of a case in which an end portion of a member forming the difference in the level is positioned in the light-shielded pixel region 20. Alternatively, the end portion of such a member may be positioned in the light receiving pixel region 10 or the peripheral circuit region 30. In other words, the region 60 (first region) includes at least part of the light receiving pixel region 10, and the region 50 (second region) includes the other regions. In addition, the first to the fourth exemplary embodiments can be appropriately changed or combined.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2014-146012, filed Jul. 16, 2014 and 2015-103997, filed May 21, 2015, which are hereby incorporated by reference herein in their entirety.

What is claimed is:

1. A photoelectric conversion apparatus having a first region including a photoelectric conversion element, and a second region, the photoelectric conversion apparatus comprising:
a first light shielding film arranged in the second region in a planar view;
a second light shielding film arranged in the first region and the second region so as to overlap with the first light shielding film in a planar view; and
a color filter layer including color filters with a plurality of colors that is provided across the first region and the second region, and positioned above the first light shielding film and the second light shielding film,
wherein the color filter layer includes a color filter with a first color that extends from, in a planer view, a region in which the first light shielding film and the second light shielding film overlap with each other to a region in which the second light shielding film is provided and the first light shielding film and the second light shielding film do not overlap with each other, so as to cover a difference in the level caused by the first light shielding film,
wherein the color filter with the first color has a first thickness dl at a first position in the first region, a second thickness d2 at a second position in the second region that is above the first light shielding film, and a third thickness d3 at a third position between the first position and the second position, and
wherein the first thickness d1, the second thickness d2, and the third thickness d3 satisfy relations d3>d1 and d3>d2.

2. The photoelectric conversion apparatus according to claim 1, wherein the first thickness d1 and the second thickness d2 satisfy a relation d1≧d2.

3. The photoelectric conversion apparatus according to claim 1, wherein the first light shielding film has a fourth thickness d4,
wherein the color filter with the first color has a length d5 between a top surface at the first position and a top surface at the second position, and
wherein the fourth thickness d4 and the length d5 satisfy a relation d4>d5.

4. The photoelectric conversion apparatus according to claim 1, wherein a base film having a top surface following a shape of the first light shielding film is provided between the first light shielding film and the color filter layer.

5. The photoelectric conversion apparatus according to claim 1, wherein the color filter with the first color has a frame shape to surround the first region in a planar view.

6. The photoelectric conversion apparatus according to claim 1, wherein the second light shielding film forms a wiring layer provided below the first light shielding film.

7. The photoelectric conversion apparatus according to claim 1, wherein a region in which the first light shielding film and the second light shielding film are arranged includes an optical black pixel having a photoelectric conversion element.

8. The photoelectric conversion apparatus according to claim 1, wherein the color filter layer includes a color filter with a second color being different from the first color.

9. The photoelectric conversion apparatus according to claim 1, wherein the color filter layer is formed of resin.

10. The photoelectric conversion apparatus according to claim 9, wherein the color filter layer is formed of a photosensitive material layer.

11. An imaging system, comprising:
the photoelectric conversion apparatus according to claim 1; and
a signal processing unit configured to process a signal from the photoelectric conversion apparatus.

12. A photoelectric conversion method of apparatus having a first region including a photoelectric conversion element, and a second region, the method comprising:
arranging a first light shielding film in the second region in a planar view;
arranging a second light shielding film in the first region and the second region so as to overlap with the first light shielding film in a planar view; and
providing a color filter layer including color filters with a plurality of colors that across the first region and the second region, and positioning above the first light shielding film and the second light shielding film,
wherein the color filter layer includes a color filter with a first color that extends from, in a planer view, a region in which the first light shielding film and the second light shielding film overlap with each other to a region in which the second light shielding film is provided and the first light shielding film and the second light shielding film do not overlap with each other, so as to cover a difference in the level caused by the first light shielding film,
wherein the color filter with the first color has a first thickness dl at a first position in the first region, a second thickness d2 at a second position in the second region that is above the first light shielding film, and a third thickness d3 at a third position between the first position and the second position, and
wherein the first thickness dl, the second thickness d2, and the third thickness d3 satisfy relations d3>d1 and d3>d2.

13. The photoelectric conversion method according to claim 1, wherein the first thickness dl and the second thickness d2 satisfy a relation d1≧d2.

14. The photoelectric conversion method according to claim 1, wherein the first light shielding film has a fourth thickness d4,
wherein the color filter with the first color has a length d5 between a top surface at the first position and a top surface at the second position, and
wherein the fourth thickness d4 and the length d5 satisfy a relation d4>d5.

15. The photoelectric conversion method according to claim 1, wherein a base film having a top surface following a shape of the first light shielding film is provided between the first light shielding film and the color filter layer.

16. The photoelectric conversion method according to claim 1, wherein the color filter with the first color has a frame shape to surround the first region in a planar view.

17. The photoelectric conversion method according to claim 1, wherein the second light shielding film forms a wiring layer provided below the first light shielding film.

18. The photoelectric conversion method according to claim 1, wherein a region in which the first light shielding film and the second light shielding film are arranged includes an optical black pixel having a photoelectric conversion element.

19. The photoelectric conversion method according to claim 1, wherein the color filter layer includes a color filter with a second color being different from the first color.

20. The photoelectric conversion method according to claim 1, wherein the color filter layer is formed of resin.
